(19) United States
(12) Patent Application Publication
(10) Pub. No.: US 2021/0123688 A1
(43) Pub. Date: Apr. 29, 2021

(54) ASSEMBLY FOR STORING HEAT

(71) Applicant: Siemens Gamesa Renewable Energy GmbH & Co. KG, Hamburg (DE)

(72) Inventors: Hans-Joachim Betko, Feldafing (DE); Jennifer Verena Wagner, Hamburg (DE)

(73) Assignee: Siemens Gamesa Renewable Energy GmbH & Co. KG, Hamburg (DE)

(21) Appl. No.: 16/633,502

(22) PCT Filed: Jul. 23, 2018
(86) PCT No.: PCT/EP2018/069906

§ 371 Date: Jan. 23, 2020

(30) Foreign Application Priority Data
Jul. 24, 2017 (DE) 10 2017 212 684.1

(51) Int. Cl. F28D 20/00; C09K 5/14

(52) U.S. Cl. CPC F28D 20/0056; C09K 2103/00; C09K 5/14

(57) ABSTRACT

An assembly for storing thermal energy is provided. The assembly includes a spatial heat reservoir, a solid natural material, which is designed to store heat, and a fluid, which is designed to transfer thermal energy to the heat storage material and to remove thermal energy from the heat storage material. The heat storage material is arranged within the heat reservoir. The heat reservoir has at least one inlet and at least one outlet, through which the fluid is conducted in order to store energy and remove energy. In order to store energy, heated fluid is introduced into the heat reservoir through the inlet, thermal energy is transferred to the heat storage material there, and the fluid is conducted out of the heat reservoir through the outlet. Correspondingly, in order to remove enemy, cool fluid is introduced into the heat reservoir through the inlet, thermal energy is absorbed from the heat storage material there, and the fluid is conducted out of the heat reservoir through the outlet. An igneous rock is used as the heat storage material.

### CROSS-REFERENCE TO RELATED APPLICATIONS

This application claims priority to PCT Application No. PCT/EP2018/069906, having a filing date of Jul. 23, 2018, based on DE 10 217 212 684.1, having a filing date of Jul. 24, 2017, the entire contents of both are hereby incorporated by reference.

### FIELD OF THE TECHNOLOGY

The following relates to an arrangement for storage of thermal energy.

### BACKGROUND

With a high proportion of renewable energy (wind energy, solar energy, tidal energy, etc.) in an energy supply grid, it becomes increasingly important to intermediately store the renewable energy in order to viably combine the availability of the renewable energy with the demands of grid stability and consumer behavior.

It is known that electrical energy obtained is converted to thermal energy (heat) and intermediately stored for a limited period of time in a heat storage means.

There are known heat storage means in which solid materials are used as storage material for example rocks or ceramic or gravel. A heated fluid for example electrically heated air is used as heat transfer medium and introduced into the heat storage means. The solid storage material in the heat storage means is heated up and used for temporary energy storage.

Correspondingly, on withdrawal of energy from the heat storage means, a (cool) fluid such as air is blown into the heat storage means, heated therein and then sent to a converter system. The converter system then converts the thermal energy withdrawn from the heat storage means via the fluid (air) to electrical energy.

For example, with the aid of the heated air, the thermal energy withdrawn is converted to electrical energy by means of a water vapor circuit and using a steam turbine.

A corresponding competitive high-efficiency energy storage system must ensure high steam parameters (temperature T, power P). This is achieved only when thermal energy is stored using high temperatures. The material used for storage is thus subjected to high and possibly rapid temperature differences and accordingly has to withstand corresponding stresses (for example thermomechanical stresses).

More particularly, it is necessary to ensure that the storage material used is sufficiently thermally stable that material cracks, fractures or even structural breakdown of the storage material are avoided. Any great changes in the structure or in the volume of the storage material used would cause unwanted effects in the heat storage means.

For example, there could be formation of unplanned channels that could adversely affect the flow of the heat transfer medium in the heat storage means. There could likewise be formation of “dead regions” in the heat storage means that can no longer be reached by the heat transfer medium and hence would be lost in respect of the energy storage.

Ultimately, such defects in the heat storage means would lead to a nonuniform and hence adverse temperature distribution.

In addition, the storage material used must resist chemical reactions (e.g. oxidations), which could have adverse effects on the heat storage means at high temperatures and when using possibly moist air as transfer medium.

It is a prerequisite for the choice of a suitable heat storage material that, in spite of the thermal, mechanical or chemical processes outlined, the duration of use and lifetime and the effectiveness of the heat storage means should be optimized.

### SUMMARY

An aspect relates to a heat storage means that has been optimized with regard to use and lifetime.

An arrangement for storage of thermal energy is claimed. The arrangement comprises a heat storage means of three-dimensional configuration, a solid natural material designed for heat storage, and a fluid designed for transfer of thermal energy to the heat storage material and for withdrawal of thermal energy from the heat storage material.

The heat storage material is disposed within the heat storage means.

The heat storage means has at least one inlet and at least one outlet through which the fluid for energy storage and for energy withdrawal is guided.

Heated fluid which is hotter compared to the temperature of the heat storage material is introduced into the heat storage means via the inlet. Thermal energy is transferred therein from the fluid to the heat storage material. The cooler fluid is guided out of the heat storage means via the outlet.

Correspondingly, cooler fluid—by comparison with the temperature of the heat storage material—is introduced into the heat storage means via the inlet for energy withdrawal. Thermal energy is transferred therein from the heat storage material to the fluid, and the now hotter fluid is guided out of the heat storage means via the outlet.

According to the embodiment, the heat storage material used is magmatic rock.

The fluid used is air, which serves as transfer medium for energy storage or energy withdrawal.

In energy storage, the energy-richer fluid compared to the heat storage means is introduced into the heat storage means via at least one inlet opening and guided therein such that the heat storage material is heated by the fluid. With the aid of the heat storage material, the thermal energy supplied via the fluid is thus stored. The fluid which correspondingly has lower energy or is cooler after the storage is guided out of the heat storage means via the at least one outlet opening.

In energy withdrawal, cooler or lower-energy fluid compared to the storage material is introduced through at least one inlet opening into the heat storage means and guided therein such that the heat storage material heats the fluid. With the aid of the heat storage material, the fluid is thus supplied with thermal energy. The fluid which is correspondingly energy-richer after the energy withdrawal is guided out of the heat storage means via at least one outlet opening.

According to the embodiments of the invention, the material of the heat storage means consists of magmatite—magmatic rock—for example of vulcanite or plutonite. Magmatic rock or igneous rock is rock that has arisen from solidification of a rock melt (magma) due to cooling. The magmatites are one of three main groups of rocks alongside the sedimentary rocks (sedimentites) and the metamorphites.

In an exemplary embodiment, the magmatites do not include a crystalline quartz component of SiO₂ (modal 0%), since this would change its crystal structure even at atmospheric pressure and at about 575° C. In the case of correspondingly higher temperatures in the heat storage means, this avoids stresses in the rock-forming quartz grains and hence the occurrence of ultrafine cracks or flaking.

The unit “modal %” used describes the mode of a rock and denotes the relative ratio of the minerals that occur in the rock. This ratio is ascertained by counting under a microscope.

In an exemplary configuration, the magmatites do not include any glassy-amorphous components and allophane (modal 0%).

This avoids weakening of the overall mineral composite and crumbling of the rock material used for heat storage, since the substances mentioned would break up in the event of temperature variations of several hundreds of degrees Celsius.

In an exemplary configuration, the magmatites do not include any proportions of primary water-containing mineral phases (e.g. zeolites, hornblendes, clay minerals, mica, kaolin minerals, illite-smectite, chlorite etc.) (modal 0%).

This avoids the release of water of crystallization on repeated heating of these water-containing mineral phases, since this could lead to local stresses and shrinkage cracks in the heat storage material.

In an exemplary configuration, the magmatites do not include any carbonates (e.g. calcite, aragonite, dolomite) (modal 0%).

This avoids a reaction of the carbonates with subsequent formation of gaseous carbon dioxide, and weakening of the mineral composite of the heat storage material.

In an exemplary configuration, the magmatites not include any sulfates (e.g. gypsum, anhydrite) as salts (modal 0%).

This also avoids the release of water at hear temperatures, and the adverse consequences described above.

In an exemplary configuration, the magmatites do not include any chloride- or sulfate-containing salts (e.g. halite, polyhalite, sylvine, glauberite, carnallite) (modal 0%).

In an exemplary configuration, the magmatites do not include any elevated oxidic ore contents (e.g. titanomagnetites etc.) (modal <1.5%).

In each case, this avoids oxygen present in the air, the heat transfer medium, from causing a low temperature or high-temperature oxidation that would generate defects in the crystal lattice, microcracks and also mineral discoloration of the heat storage material.

In an exemplary configuration, the magmatites do not include any great enrichments of single crystals (“ore clusters composed of spinels of Cr, Ti and Fe”). An ore grain size <5 μm should be observed here as a limit.

This reduces or avoids local stresses and microcracks in the heat storage material.

In an exemplary configuration, the magmatites do not include any elevated proportions of sulfur-containing ores (e.g. pyrite, pyrrhotite) (modal <0.1%).

This avoids the formation of sulfur-containing reaction products (e.g. SO₂, SO₃) that would destabilize the rock structure of the heat storage material.

In an exemplary configuration, the magmatites include a very small proportion of chromium ore (modal <0.1%).

This avoids stresses in the mineral composite of the heat storage material resulting from different coefficients of heat transfer that would occur in the case of a local ore enrichment in cluster form.

In an exemplary configuration, the magmatites include a high to very high proportion (>90%) of inert or unreactive plagioclases with an elevated anorthite content (>50%).

The correspondingly high calcium content in the plagioclases increases the melting temperature of the solid solutions (albite-anorthite solid solution series) of the heat storage material and hence the maximum possible operating temperature of the heat storage means, which constitutes a significant advantage over other mineral phases.

Moreover, in the selection of the heat storage material, it should be ensured that these plagioclases do not have secondary alteration over a larger area.

Potassium feldspars are excluded as heat storage material, but it is possible for foids as feldspar representatives to be present in the rock in small amounts (<10%) in the heat storage material.

In an exemplary configuration, the magmatites have a high to very high proportion (modal >90%) of uniformly crystallized pyroxenes and/or olivine without many fluid inclusions. Any greater secondary mineral alterations and tectonic stresses are disadvantageous and undesirable.

In an exemplary configuration, the magmatites do not include elevated proportions of fluid (e.g. gases, liquids) (modal <0.1%). This increases the stability of the individual minerals. Otherwise, gas- and/or liquid-filled inclusions could burst on cyclical heating or cooling of the heat storage medium.

In an exemplary configuration, the magmatites do not include any metamorphous mineral phases (e.g. chlorites, hornblendes, mica etc.) and any extraneous rock inclusions (xenolites) (modal 0%).

Suitable heat storage materials are especially the anorthosite and gabbro rock types. These generally include a high to very high proportion of Ca-rich plagioclases (>An50), Mg-rich pyroxenes and olivines, and a low to very low oxidic iron ore content (titanomagnetite, ilmenite, hematite).

The correspondingly selected heat storage material forms an optimum with regard to:
thermal capacity (specific heat capacity),
thermal conductivity (heat conductivity),
thermal expansion,
structural long-term stability under thermal and mechanical stress,
behavior under thermal shock stress,
environmental compatibility,
availability,
and costs.

The heat storage material is especially suitable for use at heat storage temperatures up to 750° C.

On account of its specific homogeneous crystal structure, the heat storage material withstands rapid thermal cycling without cracks in the material.

Especially the thermal and mechanical stability of the heat storage means are prolonged considerably by the heat storage material mentioned.

### BRIEF DESCRIPTION

Some of the embodiments will be described in detail, with reference to the following figures, wherein like designations denote like members, wherein:

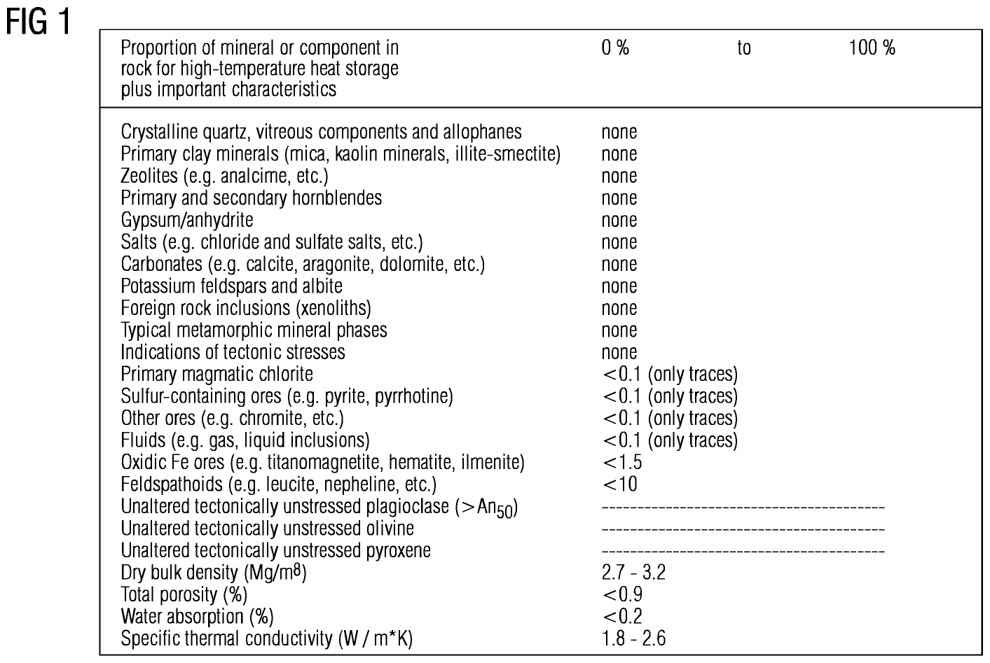

FIG. 1 properties, in tabular form, of suitable heat storage material for use in the arrangement of the invention;

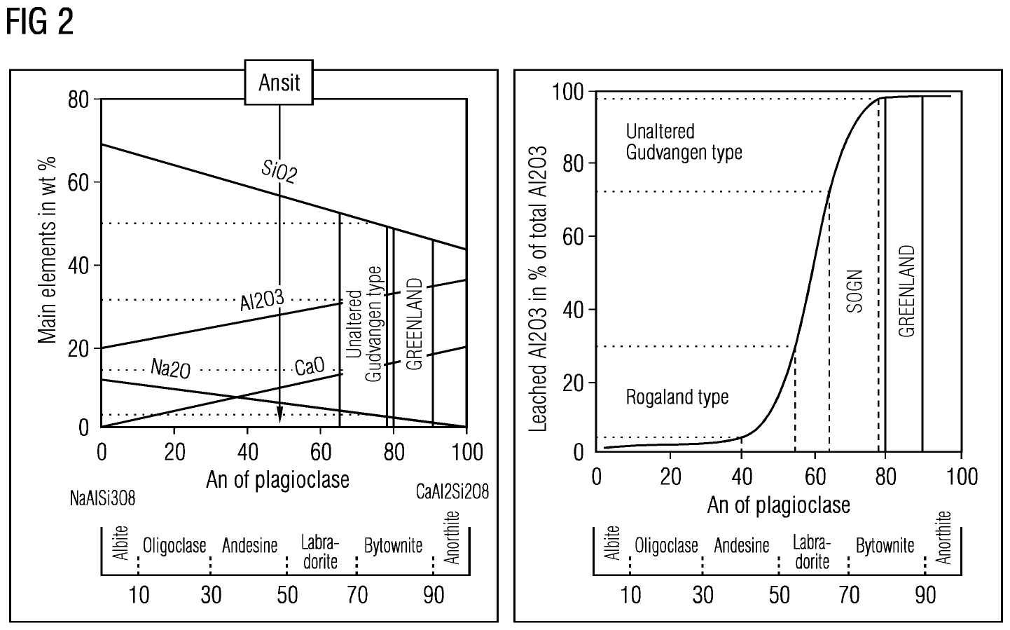

FIG. 2 the chemical and mineralogical composition of the plagioclase solid solution series in a first diagram (on the left), and the solubility of plagioclases with rising Ca content in a second diagram (on the right);

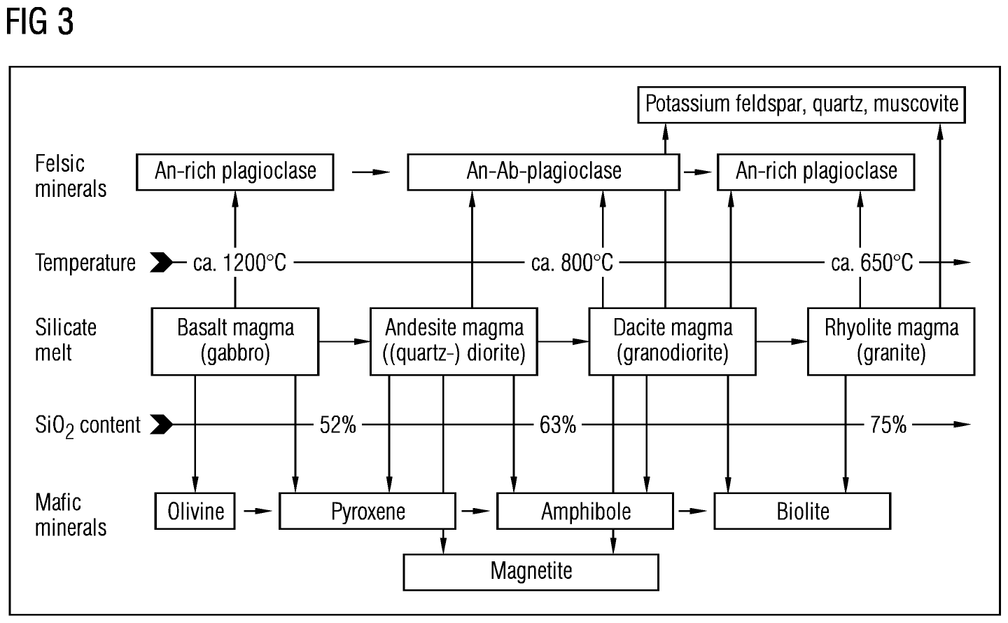

FIG. 3 a simplified scheme, in an overview, of a calc-alkaline magma differentiation;

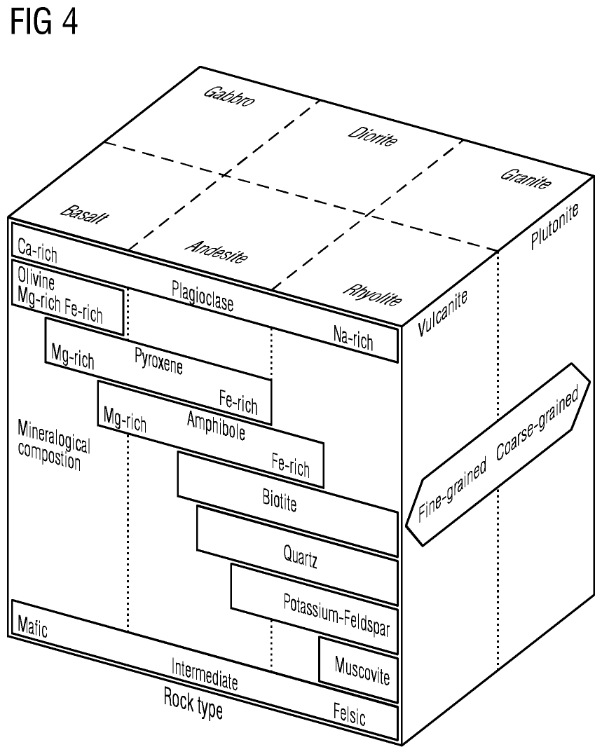

FIG. 4 an overview showing rock types particularly suitable for heat storage;

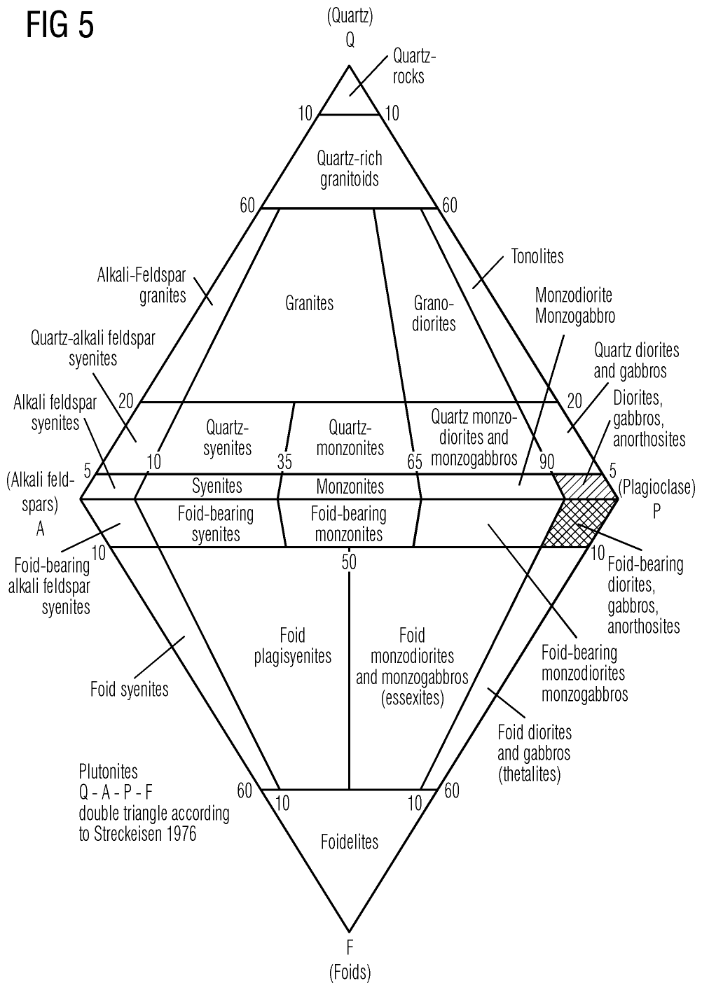

FIG. 5 an overview for illustration of the classification of the plutonites according to Streckeisen; and

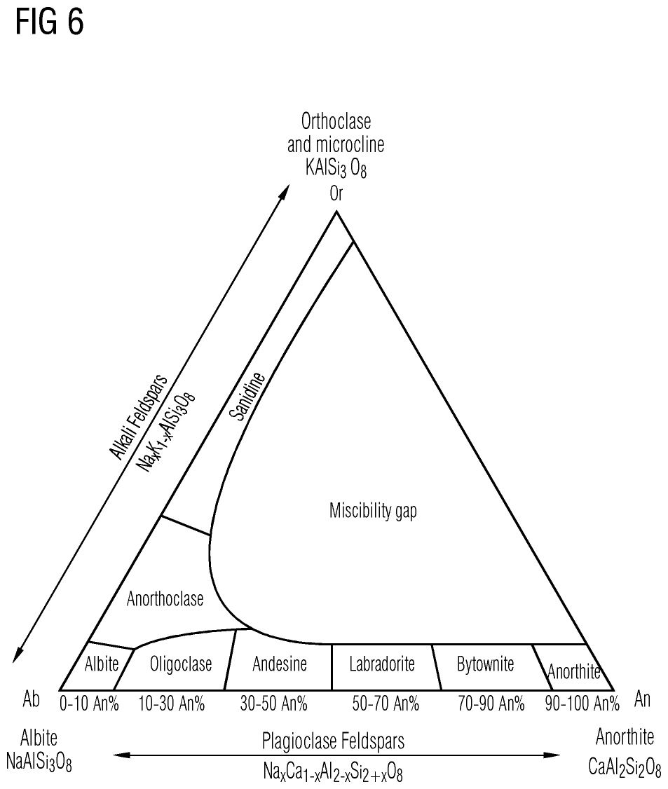

FIG. 6 an overview of the plagioclase feldspars and alkali feldspars with a respective transition for better understanding of the invention.

### DETAILED DESCRIPTION

FIG. 1 shows collated properties of suitable heat storage material which is used in the arrangement of the invention.

The overview table quantifies (modal %) the most important rock-forming minerals and the component proportions thereof, and also indices that a theoretically suitable rock must have for heat storage up to 750° C.

Moreover, important rock indices (dry bulk density, total porosity, water absorption, specific thermal conductivity) are additionally listed with limits.

Oxidic iron ores that are incorporated in the anorthosite among the plagioclase feldspars are thus partly protected from oxidation processes by atmospheric oxygen.

By virtue of the percentage of the oxidic iron ores mentioned, chemical reactions with oxygen are attenuated, and so they are negligible.

A maximum calcium content in the plagioclases (bywtonite, anorthite) generally increases the melting temperature of the heat storage material and hence increases the maximum possible operating temperature thereof and the storage capacity thereof.

FIG. 2 shows, in a first diagram (on the left), the chemical and mineralogical composition of the plagioclase solid solution series.

Plotted on a first horizontal axis is the anorthite (An) content in the plagioclase solid solution series from 0 to 100.

On a second horizontal axis beneath is plotted the respective eponymous concentration transition in the plagioclase solid solution series from left (albite, NaAlSi₃O₈) to right (anorthite, CaAl₂Si₂O₈).

Plotted on the vertical axis is the main elements in wt %.

Anorthosites (also plagioclasites) are leucocratic plutonic rocks that feature a very high proportion of plagioclases (90%-100%).

Ansite (brand name of a Norwegian anorthosite) is marked in the diagram on the horizontal axis as a suitable plagioclase-rich rock.

The two anorthites of the “Gudvangen” and “Greenland” types are marked in the diagram as particularly suitable rock types for use as heat storage material.

A second diagram (on the right) shows the solubility of anorthite-rich plagioclase with rising calcium content.

On a first horizontal axis is plotted the anorthite content in the plagioclase solid solution series from 0 to 100.

On a second horizontal axis beneath is plotted the respective eponymous concentration transition in the plagioclase solid solution series from left (albite, NaAlSi₃O₈) to right (anorthite, CaAl₂Si₂O₈).

On the vertical axis is plotted the Leached Al₂O₃ in % of total Al₂O₃.

The two anorthites of the “Gudvangen” and “Greenland” types are marked in the diagram as particularly suitable rock types for use as heat storage material.

FIG. 3 shows, in an overview, a simplified scheme of a calc-alkaline magma differentiation.

Vertical arrows point here to minerals (felsic minerals at the top, mafic at the bottom) that can occur in the respective melt, and the removal of which from the melt results in differentiation of the residual melt.

Horizontal arrows between minerals show possible crystallization processes in a differentiating melt with decreasing temperature and increasing SiO₂ content.

FIG. 4 shows an overview of rock types showing rock types particularly suitable for heat storage and their most important mineral phases.

On a horizontal axis are plotted three rock type ranges (mafic, intermediate, felsic), while mineralogical compositions are plotted on the vertical axis.

On a third axis, a distinction is made between “fine-grained” and “coarse-grained” structure.

The result is a three-dimensional block diagram for the mineralogy of magmatites.

The left-hand third of the cuboid shown shows the “basalt” and “gabbro” heat storage materials that are particularly suitable for heat storage.

FIG. 5 shows, for illustration, the classification of the plutonites according to Streckeisen.

Rocks that are potentially suitable as heat storage material lie within the diagram with the vertices of quartz (Q), alkali feldspar and albite (A), plagioclase without albite (P), and foids (F).

Heat storage materials used are diorites, gabbros, anorthosites and also foid-bearing diorites.

These are shown in the plagioclase-rich region in the right-hand region of the diagram.

FIG. 6 shows plagioclase feldspars and alkali feldspars with a respective transition for better understanding of the invention.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An arrangement for storage of thermal energy, comprising:
a heat storage means of three-dimensional configuration;
a solid natural material designed for heat storage; and
a fluid designed for transfer of thermal energy to a heat storage material and for withdrawal of thermal energy from the heat storage material;
the heat storage material is disposed within the heat storage means, and the heat storage means has at least one inlet and at least one outlet through which the fluid for energy storage and for energy withdrawal is guided;
wherein heated fluid for energy storage is introduced into the heat storage means via the at least one inlet, transfers thermal energy to the heat storage material therein and is guided out of the heat storage means via the at least one outlet;
wherein cool fluid for energy withdrawal is introduced into the heat storage means via the at least one inlet, absorbs thermal energy from the heat storage material therein and is guided out of the heat storage means via the at least one outlet;
Wherein the heat storage material is a magmatic rock.
wherein:

2. The arrangement as claimed in claim 1, wherein the fluid is air.

3. The arrangement as claimed in claim 1, wherein the heat storage material is vulcanite or plutonite.

4. The arrangement as claimed in claim 3, wherein the heat storage material is basalt or gabbro or anorthosite.

5. The arrangement as claimed in claim 1, wherein heat storage material does not include any crystalline quartz component of SiO₂.

6. The arrangement as claimed in claim 1, wherein the heat storage material does not include any glassy-amorphous components and allophane.

7. The arrangement as claimed in claim 1, wherein the heat storage material does not include any proportions of primary water-containing mineral phases.

8. The arrangement as claimed in claim 1, wherein the heat storage material does not include any carbonates.

9. The arrangement as claimed in claim 1, wherein the heat storage material does not include any sulfates as salts.

10. The arrangement as claimed in claim 1, wherein the heat storage material does not include any chloride- or sulfate-containing salts.

11. The arrangement as claimed in claim 1, wherein the heat storage material includes oxidic ore contents with a maximum modal ratio <1.5%.

12. The arrangement as claimed in claim 1, wherein the heat storage material does not include any ore cluster enrichments with an ore grain size of greater than 5 μm, where the ore clusters comprise chromium spinels, titanium spinels or iron spinels.

13. The arrangement as claimed in claim 1, wherein the heat storage material includes proportions of sulfur-containing ores with the modal ratio <0.1%.

14. The arrangement as claimed in claim 1, wherein the heat storage material has a chromium ore content corresponding to a modal ratio <0.1%.

15. The arrangement as claimed in claim 1, wherein the heat storage material has a proportion of greater than 90% of inert or unreactive plagioclases having an elevated anorthite content of greater than 50%.

16. The arrangement as claimed in claim 1, wherein the heat storage material includes a proportion of greater than 90% of uniformly crystallized pyroxenes and/or olivine, preferably lacking fluid inclusions.

17. The arrangement as claimed in claim 1, the heat storage material does not include any metamorphous mineral phases and any extraneous rock inclusions.
